(19) United States
(12) Patent Application Publication
(10) Pub. No.: US 2023/0214722 A1
(43) Pub. Date: Jul. 6, 2023

(54) FORECAST SUPPORT DEVICE, FORECAST SUPPORT METHOD AND RECORDING MEDIUM

(71) Applicants: NEC CORPORATION, Tokyo (JP); KYOTO UNIVERSITY, Kyoto-shi (JP)

(72) Inventors: Akira TANIMOTO, Tokyo (JP); Koh TAKEUCHI, Kyoto-shi (JP)

(73) Assignees: NEC CORPORATION, Tokyo (JP); KYOTO UNIVERSITY, Kyoto-shi (JP)

(21) Appl. No.: 18/145,898

(22) Filed: Dec. 23, 2022

(30) Foreign Application Priority Data
Jan. 5, 2022 (JP) 2022-000596

(51) Int. Cl. G06N 20/00

(52) U.S. Cl. CPC G06N 20/00

(57) ABSTRACT

A forecast support device acquires learning data including: a forecast value; and an actual value when the forecast value is disclosed. The forecast support device trains a model indicating a relationship between: the forecast value; and the actual value when the forecast value is disclosed, by using the learning data.

### CROSS-REFERENCE TO RELATED APPLICATIONS

This application is based upon and claims the benefit of priority from Japanese Patent Application No. 2022-000596, filed on Jan. 5, 2022, the disclosure of which is incorporated herein in its entirety by reference.

### TECHNICAL FIELD

The present disclosure relates to a forecast support device, a forecast support method, and a recording medium.

### BACKGROUND ART

Techniques related to prediction of road traffic volume and the like have been proposed. For example, Japanese Unexamined Patent Application, First Publication No. 2021-18697 describes a traffic prediction system. This system creates a prediction model using the vehicle outflow older than the predetermined timing from a predetermined exit in the vicinity of that entrance when creating a prediction model for predicting the vehicle inflow from a predetermined entrance to a road at a predetermined timing..This traffic prediction system predicts the vehicle inflow from the predetermined entrance based on the prediction model and vehicle outflow older than the prediction target timing from the predetermined exit when predicting the vehicle inflow from a predetermined entrance at a future prediction target timing.

### SUMMARY

Disclosing a forecast value seems to impact the actual value corresponding to the forecast value. It is expected that forecasting can be performed with relatively high accuracy if the impact of disclosure of the forecast value on the actual value can be reflected in the forecast value when performing forecasting.

An example object of the present disclosure is to provide a forecast support device, a forecast support method, and a recording medium capable of solving the above problem.

According to a first example aspect of the present disclosure, a forecast support device includes: a memory configured to store instructions; and a processor configured to execute the instructions to: acquire learning data including: a forecast value; and an actual value when the forecast value is disclosed; and train a model indicating a relationship between: the forecast value; and the actual value when the forecast value is disclosed, by using the learning data.

According to a second example aspect of the present disclosure, a forecast support method executed by a forecast support device includes: acquiring learning data including: a forecast value; and an actual value when the forecast value is disclosed; and training a model indicating a relationship between: the forecast value; and the actual value when the forecast value is disclosed, by using the learning data.

According to a third example aspect of the present disclosure, a non-transitory computer readable recording medium stores a program for causing a computer to execute: acquiring learning data including: a forecast value; and an actual value when the forecast value is disclosed; and training a model indicating a relationship between: the forecast value; and the actual value when the forecast value is disclosed, by using the learning data.

According to the present disclosure, when making a forecast, the impact of disclosure of a forecast value on an actual value can be reflected in the forecast value.

### BRIEF DESCRIPTION OF THE DRAWINGS

FIG. 1 is a diagram showing an example of the functional configuration of a forecast support device according to an example embodiment.

FIG. 2 is a diagram showing an example of the relationship between forecast values and actual values in the example embodiment.

FIG. 3 is a diagram showing an example of the forecast effect model according to the example embodiment.

FIG. 4 is a diagram showing an example of differences in the distribution of forecast values in the example embodiment.

FIG. 5 is a diagram showing a first example of a configuration of a model for the forecast support device according to the example embodiment to robustly perform learning of a forecast effect model against bias in the distribution of forecast values.

FIG. 6 is a diagram showing a second example of the configuration of a model for the forecast support device according to the example embodiment to robustly perform learning of a forecast effect model against bias in the distribution of forecast values.

FIG. 7 is a diagram showing a third example of the configuration of a model for the forecast support device according to the example embodiment to robustly perform learning a forecast effect model against bias in the distribution of forecast values.

FIG. 8 is a diagram showing a fourth example of the configuration of a model for the forecast support device according to the example embodiment to robustly perform learning of a forecast effect model against bias in the distribution of forecast values.

FIG. 9 is a diagram showing a first example of a plurality of points subject to forecasting in the example embodiment.

FIG. 10 is a diagram showing a second example of a plurality of points subject to forecasting in the example embodiment.

FIG. 11 is a diagram showing an example of the configuration of the forecast support device according to an example embodiment.

FIG. 12 is a diagram showing an example of a processing procedure in the forecast support method according to an example embodiment.

FIG. 13 is a schematic block diagram showing the configuration of a computer according to at least one example embodiment.

### EXAMPLE EMBODIMENT

Example embodiments of the present disclosure will be described below, but the following example embodiments does not limit the invention according to the claims. Also, all combinations of features described in the example embodiments may not be necessarily required for the solution means of the invention.

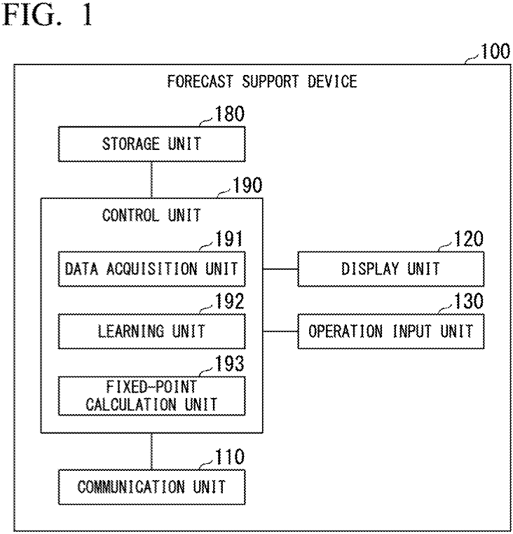

FIG. 1 is a diagram showing an example of the functional configuration of the forecast support device according to an example embodiment. With the configuration shown in FIG. 1, a forecast support device 100 includes a communication unit 110, a display unit 120, an operation input unit 130, a storage unit 180, and a control unit 190. The control unit 190 includes a data acquisition unit 191, a learning unit 192 and a fixed-point calculation unit 193.

The forecast support device 100 calculates a forecast value. Forecasting here means disclosing a forecast result. The forecast value here is a value disclosed as a forecast result in the forecast.

Whether or not the prediction result is disclosed when predictions are made may affect the actual value corresponding to the prediction result. For example, if road traffic information forecasts the time required to pass through a congested area, some drivers who are aware of the forecast will avoid the place or time when the congestion is expected. Thereby, traffic congestion is likely to be alleviated more when congestion is forecasted than when it is not forecasted.

Therefore, the forecast support device 100 calculates a forecast value so that the impact of the forecasting on the actual value is reflected in the forecast value. For this reason, the forecast support device 100 uses learning data that includes the forecast value and the actual value in the event of a forecast with that forecast value being made to train a model to calculate a forecast value that reflects the impact of the forecast being made. A measured value may be used as the actual value included in the learning data.

A model for calculating a predicted value that reflects the impact of a forecast is also called a forecast effect model. The forecast support device 100 adopts the forecast value calculated using the forecast effect model as the forecast value by the forecast support device 100. A forecast effect model corresponds to an example of a model for forecast value calculation.

It is expected that the forecast support device 100 can calculate the forecast value with relatively high accuracy when a forecast is made, in that the forecast value is calculated reflecting the effect of the forecast.

The following description is a case in which the forecast support device 100 calculates a forecast value of the degree of congestion of a road. For example, the forecast support device 100 may calculate the distance of congestion (length of congestion) at a designated date and time and at a designated location, or the time required to pass through the congestion as a forecast value.

However, the target for which the forecast support device 100 calculates the forecast value is not limited to a specific one, and may be various items whose actual values may differ depending on the presence or absence of a forecast.

For example, the forecast support device 100 may calculate forecast values of monetary prices such as stock prices or exchange rates. In the case of stock prices, the stock will be bought, leading to a rise in the stock price when the forecast support device 100 calculates the future stock price forecast value and the calculated price is high. Conversely, the stock will be sold, leading to a fall in the stock price when the forecast support device 100 calculates the future stock price forecast value to be low.

Alternatively, the forecast support device 100 may calculate a forecast value for the number of people infected with a given disease. When the forecast support device 100 calculates that the forecast value of infected people to be a large number, it is conceivable that the number of infected people will decrease as people become more wary of infection. On the other hand, when the forecast support device 100 calculates the forecast value of infected people to be a small number of people, it is conceivable that people seem to be less wary of infection and then the number of infected people increases.

Alternatively, the forecast support device 100 may calculate the forecast value of votes in an election. When the forecast support device 100 calculates the forecast value of votes for a certain candidate to be a small number of votes, it is conceivable that voters who regard the candidate as having a small chance of being elected will vote for other candidates, leading to a decrease in the number of votes for the candidate whose forecast value of votes obtained is calculated to be a small number.

Alternatively, the forecast support device 100 may calculate the demand forecast value for a product. When the forecast support device 100 calculates that the number of sales of a certain product is large, it is conceivable that the product will become conspicuous by being stocked in large quantities and displayed en masse, facilitating sales of the product. Furthermore, it is conceivable that a certain customer’s purchase of the product will have an advertising effect on other customers, making the product more likely to sell.

The communication unit 110 communicates with other devices. For example, the communication unit 110 may receive learning data used for learning the forecast effect model from a database device that stores learning data. Further, the communication unit 110 may forecast by transmitting the forecast value calculated by the forecast support device 100 to a device connected to the Internet.

The display unit 120 has a display screen such as a liquid crystal panel or an LED (Light Emitting Diode) panel, and displays various images. For example, the display unit 120 may display the forecast value calculated by the forecast support device 100.

The operation input unit 130 includes input devices such as a keyboard and a mouse, and receives user operations. For example, the operation input unit 130 may receive a user operation instructing calculation of forecast values. Further, the operation input unit 130 may receive a user operation for instructing the start of learning of the forecast effect model.

The storage unit 180 stores various data. For example, the storage unit 180 stores a forecast effect model. The storage unit 180 is configured to use a storage device included in the forecast support device 100.

The control unit 190 controls each unit of the forecast support device 100 to perform various processes. The functions of the control unit 190 are executed by, for example, a CPU (Central Processing Unit) included in the forecast support device 100 reading a program from the storage unit 180 and executing the program.

The data acquisition unit 191 acquires learning data for learning the forecast effect model. In particular, the data acquisition unit 191 acquires learning data including a forecast value and an actual value when a forecast is made of the forecast value. For example, when the communication unit 110 receives learning data, the data acquisition unit 191 may extract learning data from the data received by the communication unit 110.

The data acquisition unit 191 corresponds to an example of a data acquisition means.

The learning unit 192 uses the learning data acquired by the data acquisition unit 191 to learn the forecast effect model described above for the forecast support device 100. Learning the forecast effect model may be to set or update the parameter values of the forecast effect model.

The learning unit 192 performs learning of the forecast effect model so that the forecast effect model receives the input of the forecast value and outputs a forecast value with higher accuracy when a forecast is made with the forecast value. The learning of the forecast effect model by the learning unit 192 can be said to be learning of the relationship between the forecast value and the actual value when the forecast of that forecast value is made.

The learning unit 192 corresponds to an example of a learning means.

The fixed-point calculation unit 193 calculates a forecast value at which, when a forecast is made, the forecast value and the actual value are estimated to match. Specifically, the fixed-point calculation unit 193 uses the forecast effect model to calculate a forecast value such that the forecast value input to the forecast effect model matches the forecast value output from the forecast effect model. The forecast value when the forecast value input to the forecast effect model and the forecast value output from the forecast effect model match is also called a fixed point.

The forecast value output by the forecast effect model can be said to be an estimated value of the actual value when a forecast with the forecast value is performed.

The fixed-point calculation unit 193 corresponds to an example of a fixed-point calculation means.

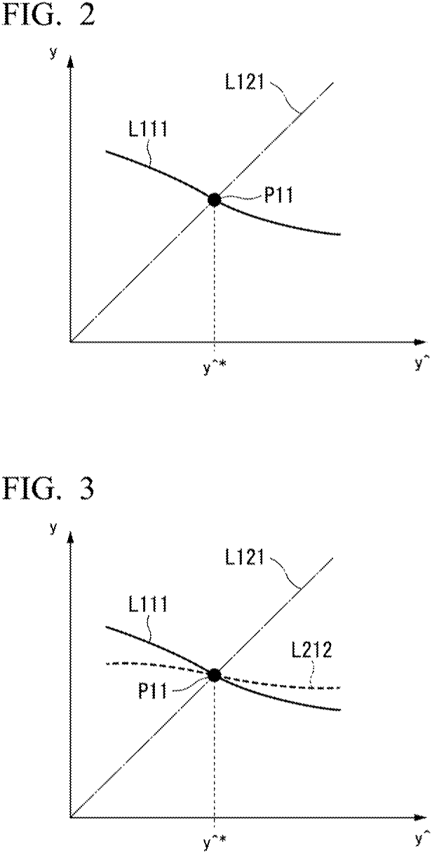

FIG. 2 is a diagram showing an example of the relationship between forecast values and actual values.

The horizontal axis of the graph in FIG. 2 represents forecast values. A forecast value is written as y^. The vertical axis of the graph in FIG. 2 represents actual values when a forecast is made that the forecast value is y^. The actual value is written as y when the forecast value is forecast as y^.

Here, consider the case where there is a relationship represented by Equation (1) between the forecast value y^ and the actual value y.

$$y = f \left(x , y \hat{}\right)$$

x denotes a parameter that indicates a condition of the forecast, such as the date and time and location of the target of the forecast. x is also called a condition parameter. The value of condition parameter x is called a condition parameter value. A condition parameter value is also written as x.

The condition parameter value x and the actual value y may each be a vector or a scalar. When the condition parameter value x or the actual value y is a vector, the number of dimensions thereof (the number of elements of the vector) is not limited to a specific number of dimensions.

The forecast value y^ is of the same type as the actual value y. For example, when the actual value y is represented by a vector, the forecast value y^ is also made to be represented by a vector having the same number of dimensions as the actual value y.

The line L111 in FIG. 2 shows an example of the relationship between the forecast value y^ and the actual value y when the condition parameter value x is set to a certain value.

The line L121 represents a line where y = y^.

Point P11 represents the intersection of line L111 and line L121. The forecast value y^ at the point P11 is written as forecast value y^*.

At the point P11, y = y^, so the forecast value y^ matches the actual value y when the forecast value y^ is forecast. That is, for the forecast value y^*, Equation (2) is valid.

$$y \hat{} * = f \left(x , y \hat{} *\right)$$

Therefore, when the forecast support device 100 can accurately obtain the forecast value y^*, a forecast can be made accurately by forecasting with the forecast value y^*. For example, if a forecast effect model that accurately simulates the function f is obtained, the forecast value y^* is obtained as the forecast value y^ at which the forecast value y^ input to the forecast effect model and the forecast value output by the forecast effect model (estimated value of the actual value y) match. By outputting this forecast value y^*, the forecast support device 100 can accurately calculate the forecast value y^.

The forecast value y^* in this case corresponds to an example of a fixed point.

Alternatively, the forecast effect model need only be able to find the forecast value y^* that corresponds to the fixed point, and need not precisely represent the relationship between the forecast value y^ and the actual value y.

FIG. 3 is a diagram showing an example of a forecast effect model.

The horizontal axis of the graph in FIG. 3 represents the forecast value y^. The vertical axis of the graph in FIG. 3 shows the actual value y when the forecast is made that the forecast value is y^.

Line L111, line L121 and point P11 are the same as in FIG. 2. Also, similarly to the case of FIG. 2, the forecast value y^ at the point P11 is written as the forecast value y^*.

Line L212 represents an example of the forecast effect model. In the example of FIG. 3, the forecast effect model accurately simulates the relationship between the forecast value y^ and the actual value y at the point P11 where the forecast value is y^*. On the other hand, for the forecast values y^ other than the forecast value y^*, the actual value y indicated by the line L111 deviates from the estimated value by the forecast effect model indicated by the line L212.

As described above, the forecast support device 100 can accurately calculate the forecast value y^ by calculating y^* as the forecast value. Therefore, as in the example in FIG. 3, the forecast support device 100 can accurately calculate the forecast value y^ even when the estimated value by the forecast effect model is not accurate for forecast values y^ other than the forecast value y^*.

The forecast support device 100 can be applied even when it is not possible to actually obtain the relationship between the forecast value y^ and the actual value y illustrated by the function f. For example, when the forecast support device 100 calculates a forecast value for the degree of congestion of a road, there is at most only one forecast for a specific date and time and a specific location. Therefore, it is not possible to measure the actual value y for each of a plurality of predicted values y^ for a specific date and time and a specific place.

In contrast, in the forecast support device 100, the learning unit 192 can use as learning data a plurality of combinations of the forecast value y^ and actual value y, such as the forecast value y^ and actual value y at the same time of the same day and the same place, for example, where the relationship between the forecast value y^ and actual value y is considered similar. Thereby, the learning unit 192 can perform learning of the forecast effect model using the actual value y for each of a plurality of forecast values y^. Then, the fixed-point calculation unit 193 can obtain the forecast value y^* at which the forecast value y^ input to the forecast effect model and the forecast value output by the forecast effect model match as the forecast value y^ by the forecast support device 100.

Thus, even if the actual relationship between the forecast value y^ and the actual value y is not determined even after the fact, the forecast support device 100 can calculate the forecast value reflecting the influence of a forecast being made.

The learning unit 192 may perform learning of the forecast effect model so that the relationship between forecast values based on the forecast effect model and actual values is monotonically non-increasing. For example, the learning unit 192 may performs learning of the forecast effect model using an objective function including the terms shown in Equation (3).

$$\frac{1}{N} {\sum }_{n}^{N} \text{max} \left({\left(0 , \frac{\partial f}{\partial y \hat{}}\right|}_{{x}_{n} , y {\hat{}}_{n}}\right)$$

Here, learning data D shall be represented as Equation (4).

$$D = \left\{{x}_{n} , y {\hat{}}_{n} , {y}_{n}\right\}$$

n is an identification number for identifying a sample of learning data, where n = 1, 2, ..., N. N is a positive integer indicating the number of learning data samples. That is, the learning data D is configured including N samples.

xₙ is a sample of the parameter x indicating a forecast condition. y^ₙ is a sample of the forecast value y^. yₙ is a sample of the actual value when a forecast with the forecast value y^ₙ is made.

Equation (3) shows a penalty term that, when the slope “∂f/∂y^” of the function f indicating the forecast effect model is 0 or negative, sets the penalty to 0, and when the slope “∂f/∂y^” is positive, sets the penalty to a value obtained by dividing that positive value by the number of samples N. The learning unit 192 performs learning of the forecast effect model so as to minimize the penalty function including Equation (3), which corresponds to normalizing the forecast effect model so that it is monotonically non-increasing.

Since the forecast effect model (function f) is monotonically non-increasing, there is only one intersection between y = f(x, y^) and y = y^. In this respect, the forecast support device 100 can stably obtain the fixed point forecast value y^*.

Thus, during learning, the learning unit 192 performs learning of the forecast effect model. During operation, the fixed-point calculation unit 193 detects the fixed point forecast value y^* in the forecast effect model, and decides to forecast using this forecast value y^*.

The fixed-point calculation unit 193 may search for the fixed point forecast value y^* using a known solution search method such as Newton’s method.

The learning unit 192 may perform the learning using an evaluation function that gives a lower evaluation when the magnitude correlation of the actual value y when a forecast of a certain forecast value y^ is made and the estimated value f(x,y^) of the actual value y^ when the forecast of that forecast value y^ is made, and the magnitude correlation of the actual value y and the forecast value y^ do not match.

As a result, the learning unit 192 performs learning of the forecast effect model so that, for example in FIG. 3, the side on which the estimated value f(x, y^) of the actual value y^ is plotted among the left and right sides of the line L121 on the line L212 matches the side on which the forecast value y^ is plotted among the left and right sides of the line L121 on the line L111. In this regard, it is expected that the learning unit 192 performs learning of the forecast effect model so that the fixed-point calculation unit 193 can obtain the fixed point with high accuracy.

Regarding the learning of the forecast effect model by the learning unit 192, since the actual value y fluctuates according to the forecast value y^, it is conceivable that the forecast value y^ given as learning data and the forecast value output by the forecast support device 100 may deviate. This deviation corresponds to the deviation between the distribution of the forecast value y^ in the learning data and the distribution of the forecast value y^ during operation, and leads to a decrease in the accuracy of learning of the forecast effect model by the learning unit 192.

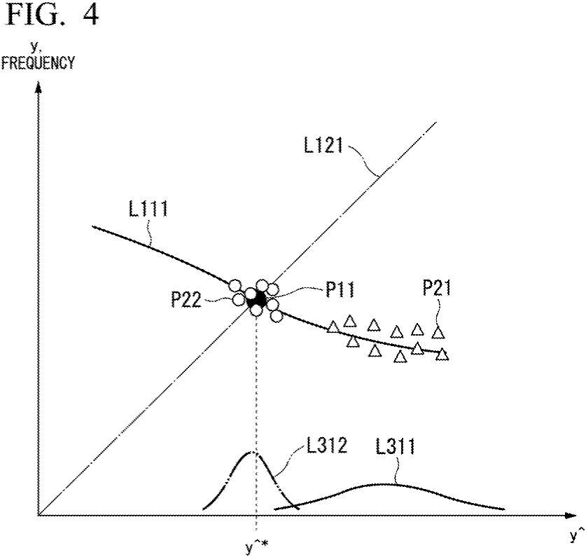

FIG. 4 is a diagram showing an example of a difference in distribution of forecast values y^. The horizontal axis of the graph in FIG. 4 represents the forecast value y^. The vertical axis of the graph in FIG. 4 indicates the actual value y when a forecast is made that the forecast value is y^, and the frequency of the forecast value y^.

Here, consider a case where there is a relationship approximated by a line L111 between the forecast value y^ and the actual value y when the condition parameter value x is a certain value.

The line L121 represents a line where y = y^.

Point P11 represents the intersection of line the L111 and the line L121. The forecast value y^ at the point P11 is written as forecast value y^*.

The point P21 indicated by the white triangle indicates an example of a forecast value and an actual value when the forecast effect is not considered. The point P22 indicated by the white circle indicates an example of a forecast value and an actual value when the forecast effect is considered.

Compared to the case where the forecast effect is taken into account, when the forecast effect is not taken into account, the forecast is made with a relatively large forecast value y^, leading to the actual value y becoming a relatively small value due to the effect of the forecast being made.

A line L311 shows an example of the frequency distribution of the forecast value y^ when the forecast effect is not considered. In this case, the forecast values y^ are numerous over a relatively large distribution.

On the other hand, when considering the forecast effect, the forecast is made with a relatively small forecast value y^, leading to the actual value y that is approximately the same as the forecast value y^.

A line L312 shows an example of the frequency distribution of the forecast value y^ when the forecast effect is taken into account. In this case, a large distribution of the forecast values y^ is over a smaller area than when the forecast effect is not considered that is indicated by line L311.

When the forecast support device 100 acquires the learning data when the forecast effect is not taken into account to perform learning of the forecast effect model, and calculates the forecast value y^ considering the forecast effect during operation, deviations arise in the distribution of the forecast values y^ between learning and operation. The distribution of predicted values y^ during learning is illustrated by line L311, while the distribution of predicted values y^ during operation is illustrated by line L312.

On the other hand, the learning unit 192 may robustly perform learning of the forecast effect model with respect to the shift in the distribution of the forecast values y^. For example, if the forecast value y^ indicated in the learning data is uniformly distributed, it is expected that learning can be performed with relatively high accuracy as normal supervised machine learning. From this, when the distribution of the forecast values y^ included in the learning data is biased in comparison with the uniform distribution, learning of the forecast effect model for forecast value calculation may be performed in a robust manner with respect to the bias in the distribution of the forecast values.

Here, the learning of the forecast effect model being robust against a bias in the distribution of the forecast values y^ means that the bias in the data of the distribution of the forecast values y^ given in the learning data has little effect on the accuracy of the forecast values output by the forecast effect model.

In the following, the model may be described using the notation of the function that indicates the model. For example, the forecast effect model is also referred to as forecast effect model for forecast effect model f(x, y^).

The estimated value of the actual value y when the forecast is made with the forecast value y^, which is output by the forecast effect model f, is also written as the estimated value y^^{c}

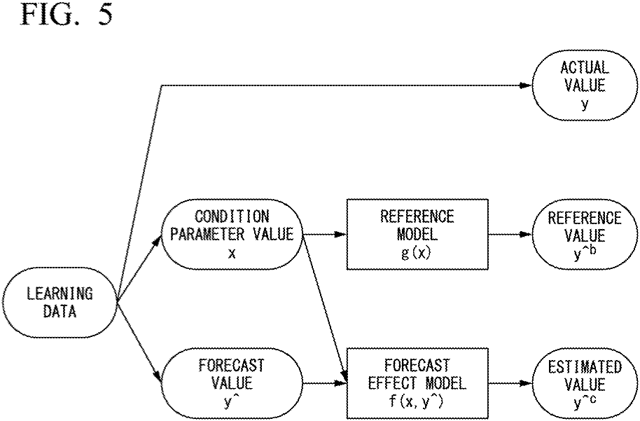

FIG. 5 is a diagram showing a first example of a configuration of a model for the forecast support device 100 to robustly perform learning of the forecast effect model against the bias in the distribution of forecast values y^. In the example of FIG. 5, a reference model g(x) is provided in addition to the forecast effect model f(x,y^).

The reference model g receives the input of the condition parameter value x and outputs the reference value y^^{b}.

The reference value y^^{b} is a value determined according to the condition parameter value x, and indicates the average value of the actual value y for various forecast values y^.

For example, the learning unit 192 performs learning of the reference model g using the condition parameter value x and the actual value y among the learning data of combinations of: the condition parameter value x; the forecast value y^; and the actual value y when the forecast value y^ is forecasted, ignoring the forecast value y^. Ignoring the forecast value y^ here means not using the forecast value y^ as an input to the reference model g.

In this way, since the learning unit 192 may perform learning of the reference model g with the actual value y as the correct answer, the reference value y^^{b} which is the output value of the reference model g, corresponds to the estimated value of the actual value y by the reference model g.

One way to use the forecast effect model f is to obtain the fixed point forecast value y^* where the forecast value y^ and the actual value y when the forecast with the forecast value y^ is made match. The fixed point forecast value y^* can be said to be a forecast value that enables highly accurate forecasting.

In this case, it is considered preferable to perform the learning of the forecast effect model f so as to avoid the actual value y being small despite the forecast value y^ being large, and avoid the actual value y being large despite the forecast value y^ being small.

To avoid the actual value y being small despite the forecast value y^ being large, and the actual value y being large despite the forecast value y^ being small, the learning unit 192 may perform learning of the forecast effect model f using an evaluation function in which the smaller the value of ER shown in Equation (5), the higher the evaluation.

$$E R = - \frac{1}{N} \sum \left(s \text{log} \left(v\right) + \left(1 - s\right) \text{log} \left(1 - v\right)\right)$$

In Equation (5), log represents a logarithmic function. N indicates the number of samples used for learning. The samples referred to here are individual samples in the learning data as shown in Equation (4) above.

s is shown as in Equation (6).

$$s = I \left(y - g \left(x\right) \geq 0\right)$$

y here is the actual value included in the sample and indicates the correct value of the output of the forecast effect model f for the condition parameter value x and the forecast value y^ specified by the sample.

The reference model g is a model that has learned the relationship between the condition parameter value x and the actual value y, as described above. The value of the reference model g is used as the average of the actual value y when the condition parameter value x has been determined.

I is a function whose value is 1 when the argument value is true and whose value is 0 when the argument value is false. Therefore, the value of I(y-g(x) ≥ 0) is 1 if y ≥ g(x) and 0 if y < g(x).

v is shown as in Equation (7).

$$v = σ \left(f \left(x , y \hat{}\right) - g \left(x\right)\right)$$

σ indicates a sigmoid function. Therefore, v takes a value of 0 < v < 1, and so “log(v)” in Equation (5) takes a negative value. That is, log(v) < 0. Also, the larger the value of f(x,y^)-g(x), the larger the value of “log(v)”. That is, the larger the value of f(x,y^)-g(x), the more “log(v)” becomes a negative value with a small magnitude |log(v)|.

From Equation (6), if y < g(x), then s = 0 and the value of “s log(v)” in Equation (5) is zero. On the other hand, if y ≥ g(x) and f(x, y^) < g(x), then the value of “s log(v)” will be a relatively small negative value, and if y ≥ g(x) and f(x,y^) ≥ g(x), then the value of “s log(v)” will be a relatively large negative value. A small negative value here is a negative value with a large magnitude (absolute value), and a large negative value is a negative value with a small magnitude (absolute value).

Thus, the value of “s log(v)” in Equation (5) is relatively small and negative for y ≥ g(x) and f(x, y^) < g(x), otherwise it is 0 or a negative value close to 0 (a relatively large negative value).

Also, from Equation (7), 1-v takes a value of 0 < 1-v < 1, and “log(1-v)” in Equation (5) takes a negative value. Also, the larger the value of f(x,y^)-g(x), the smaller the value of 1-v, and the smaller the value of “log(1-v)”. That is, the larger the value of f(x,y^)-g(x), the more the “log(1-v)” becomes a negative value with a large magnitude |log(1-v)|.

From Equation (6), if y ≥ g(x), then 1-s = 0 and the value of “(1-s)(1-log(v))” in Equation (5) is zero. On the other hand, if y < g(x) and f(x, y^) ≥ g(x), the value of “(1-s)(1-log(v))” becomes a relatively small negative value. If y < g(x) and f(x, y^) < g(x), then the value of “(1-s)(1-log(v))” becomes a relatively large negative value.

Thus, the value of “(1-s) (1-log(v))” in Equation (5) is a relatively small negative value when y < g(x) and f(x, y^) ≥ g(x), otherwise it will be 0 or a negative value close to 0 (a relatively large negative value).

Therefore, among the samples used for learning of the forecast effect model f, the greater the proportion of samples in which “(y ≥ g(x) and f(x,y^) < g(x)) or (y < g(x) and f(x, y^) ≥ g(x))”, the larger the value of ER. Therefore, by the learning unit 192 performing learning of the forecast effect model f(x, y^) so that the value of ER becomes small, it is expected that when f(x,y^) ≥ g(x) then y ≥ g(x), and when f(x,y^) < g(x) then y < g(x).

As described above, the learning unit 192 may perform learning of the forecast effect model f using an evaluation function that gives a higher evaluation the smaller the ER value.

For example, the learning unit 192 may perform learning of the forecast effect model f using an evaluation function that gives a higher evaluation the smaller the value of L shown in Equation (8).

$$L = \sqrt{M S E ⋅ E R}$$

MSE indicates the mean squared error between the estimated value y^^{c}, which is the output of the model f, and the actual value y, which is the correct value. The smaller the value of L, the smaller the mean square error between the estimated value y^^{c} and the actual value y, and in this respect, the accuracy of the forecast effect model f is high. Also, the smaller the value of L, as described above for ER, it is expected that when f(x,y^) ≥ g(x) then y ≥ g(x), and when f(x,y^) < g(x) then y < g(x).

When the learning unit 192 performs learning of the forecast effect model f using an evaluation function (that is, loss function) that gives a higher evaluation the lower the function value, an evaluation function including L as one of the terms, or an evaluation function including a term that multiplies L by a positive coefficient may be used.

When the learning unit 192 performs learning of the forecast effect model f using an evaluation function that gives a higher evaluation as the function value increases, an evaluation function including -L as one of the terms, or an evaluation function including a term that multiplies L by a negative coefficient may be used.

The process of calculating the value of L is not limited to the process of calculating the geometric mean shown in Equation (8), and may be, for example, the process of calculating an arithmetic mean, or the process of calculating a weighted average.

The learning unit 192 first performs learning of the reference model g using learning data. After completing the learning of the reference model g, the learning unit 192 calculates the reference value y^^{b} for each sample of the learning data. The data acquisition unit 191 generates learning data in which the reference value y^^{b} is added in the sample. The learning unit 192 performs learning of the forecast effect model f using the learning data including the reference value y^^{b}.

Alternatively, instead of the data acquisition unit 191 generating learning data including the reference value y^^{b} each time the learning unit 192 applies a sample to the learning of the forecast effect model f, the learning unit 192 may calculate the output of the model g (that is, the reference value y^^{b}) in the case of that sample.

Thus, according to the forecast support device 100, it is expected that the magnitude relationship between the estimated value y^^{c} and the reference value y^^{b} and the magnitude relationship between the actual value y and the reference value y^^{b} will match. That is, when the estimated value y^^{c} is greater than the reference value y^^{b} the actual value y is also expected to be greater than the reference value y^^{b}. Also, when the estimated value y^^{c} is smaller than the reference value y^^{b}, the actual value y is also expected to be smaller than the reference value y^^{b}.

According to the forecast support device 100, in this respect, the error between the estimated value y^^{c} and the actual value y can be small and the estimated value y^^{c} can be calculated with high accuracy.

In addition, since the forecast value y^ is not included in the argument in the reference model g(x), y^^{b}, which is subject to comparison in the above magnitude relationship, is constant regardless of the distribution of the forecast value y^. Moreover, even when the distribution of the reference value y^^{b} differs, it is expected that the above magnitude relationship is the same. According to the forecast support device 100, in this respect, the forecast effect model can be robustly learned against deviations in forecast values.

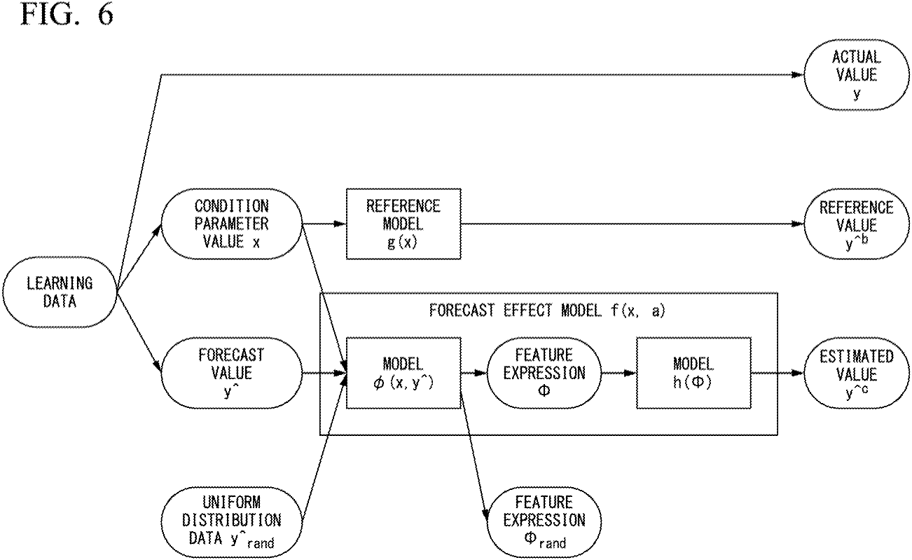

FIG. 6 is a diagram showing a second example of the configuration of a model for the forecast support device 100 to robustly performs learning of the forecast effect model against the bias in the distribution of the forecast values y^.

In the example of FIG. 6, the model ϕ receives the input of the condition parameter value x and the forecast value y^ and outputs the feature expression (feature). The model ϕ is also written as ϕ(x,y^). The feature expression output by the model ϕ is data indicating the features of the condition parameter value x and the forecast value y^ that are the input data to the model ϕ. This feature expression is written as Φ. A feature expression may be represented by a real vector. A real vector in this case is also called a feature vector. A feature expression is also called a feature amount (feature).

The model h receives an input of the feature expression Φ and outputs the estimated value y^^{c}. The model h is also written as h(Φ).

A forecast effect model f is constructed by combining the model ϕ and the model h.

In the example of FIG. 6, the learning unit 192 performs model learning (particularly, learning of the model ϕ) so as to accommodate deviations in the distribution of input data between learning and operation of the model ϕ and the model h.

As described with reference to FIG. 4, there is a discrepancy between the distribution of forecast values y^ indicated by learning data and the distribution of forecast values during operation indicated by estimated values y^^{c}. Therefore, it is preferable that the forecast effect model f can be learned for forecast values y^ other than the forecast values y^ indicated in the learning data.

Therefore, the learning unit 192 performs learning of the model ϕ using uniformly distributed data randomly sampled based on a uniform distribution of the forecast values y^. The uniformly distributed data is written as y^_{rand}.

The learning unit 192 performs learning of the model ϕ so that the distribution of the feature expression Φ is the same when using the forecast value y^ included in the learning data and when using the uniformly distributed data y^_{rand}.

The feature expression Φ when using the forecast value y^ included in the learning data is the feature expression Φ output by the model ϕ in response to the input of a combination of the forecast value y^ and the condition parameter value x included in the learning data sample. The feature expression Φ when using the uniformly distributed data y^_{rand} is the feature expression Φ output by the model Φ upon receiving the input of a combination in which the forecast value y^ is replaced with the uniformly distributed data y^_{rand}, from the combination of the forecast value y^ and the condition parameter value x included in the learning data sample.

Here, the feature expression when using the uniformly distributed data y^_{rand} is written as Φ_{rand} to distinguish it from the feature expression Φ when using the forecast value y^ included in the learning data.

The learning unit 192 further performs learning of the model h using learning data in which the feature expression ϕ that is output by the learned model ϕ upon receiving input of the combination of the condition parameter value x and the forecast value y^ included in the learning data sample, and the actual value included in the sample are associated.

The forecast value y^ included in the learning data is converted by the model ϕ into a feature expression Φ that exhibits a similar distribution to the feature expression Φ_{rand} in the case of the uniformly distributed data y^_{rand}. As a result, the learning unit 192 can perform learning of the model h so as to reflect the relationship between the forecast value y^ and the actual value y included in the learning data in the model h for not only the forecast value y^ indicated by the learning data but also the entire distribution of the forecast value y^. In this respect, it is expected that the forecast effect model f, which is a combination of the model ϕ and the model h, has high accuracy.

The method by which the data acquisition unit 191 acquires the uniformly distributed data y^_{rand} is not limited to a specific method. For example, the data acquisition unit 191 may acquire, as the uniformly distributed data y^_{rand}, data randomly selected by a model from a uniform distribution of the forecast values y^. Alternatively, the data acquisition unit 191 may acquire uniformly distributed data y^_{rand} created by a person such as the user of the forecast support device 100.

The learning unit 192 may acquire the uniformly distributed data y^_{rand} instead of the data acquisition unit 191.

Regarding the learning of the model ϕ, the learning unit 192 may perform learning of the model ϕ such that the inter-distribution distance between the distribution of the feature expressions Φ and the distribution of the feature expressions Φ_{rand} becomes small. For example, the learning unit 192 may perform learning of the model ϕ so as to minimize the inter-distribution distance using an evaluation function including the inter-distribution distance between the distribution of the feature representations Φ and the distribution of the feature representations Φ_{rand}. Further, the learning unit 192 may perform learning of the model ϕ such that the inter-distribution distance between the distribution of the feature representations Φ and the distribution of the feature representations Φ_{rand} is less than or equal to a predetermined threshold.

The inter-distribution distance in this case is shown as Equation (9).

$${D}_{I P M} \left(\left\{ϕ \left(x , y \hat{}\right)\right\} , \left(\left\{ϕ \left(x , y {\hat{}}_{r a n d}\right)\right\}\right)\right)$$

D_{IPM} (Integral Probability Metric) indicates the inter-distribution distance between two distributions indicated by an argument. “{ϕ(x,y^)}” indicates a set of feature expressions Φ output by the model ϕ when the forecast value y^ included in the learning data is used. “{ϕ(x,y^_{rand})}” indicates a set of feature expressions Φ_{rand} output by the model ϕ when the uniformly distributed data y^_{rand} is used.

The inter-distribution distance is an index indicating the degree of matching between two distributions. The inter-distribution distance used by the learning unit 192 is not limited to a specific one. For example, the learning unit 192 may use the MMD (Maximum Mean Discrepancy) or the Wasserstein distance as the inter-distribution distance, but is not limited thereto.

As described above, the model ϕ outputs the feature expression Φ in response to the input of the condition parameter value x and the forecast value y^. The learning unit 192 performs learning of the model ϕ so that the inter-distribution distance between the distribution of the feature expression Φ output by the model ϕ in response to input of the condition parameter value x and the forecast value y^ included in the learning data and the distribution of the feature expression Φ_{rand}. output by the model ϕ in response to input of the condition parameter value x and the forecast value y^_{rand} randomly selected based on a uniform distribution becomes small.

According to the learned model ϕ, the forecast value y^ included in the learning data is converted into a feature expression ϕ that exhibits a similar distribution to the feature expression Φ_{rand} in the case of the uniformly distributed data y^_{rand}. As a result, the learning unit 192 can perform learning of the model h so as to reflect the relationship between the forecast value y^ and the actual value y included in the learning data in the model h for not only the forecast value y^ indicated by the learning data but also the entire distribution of the forecast value y^. In this respect, it is expected that the forecast effect model f, which is a combination of the model ϕ and the model h, has high accuracy.

Thus, according to the forecast support device 100, the forecast effect model can be learned robustly against the bias in the distribution of forecast values y^.

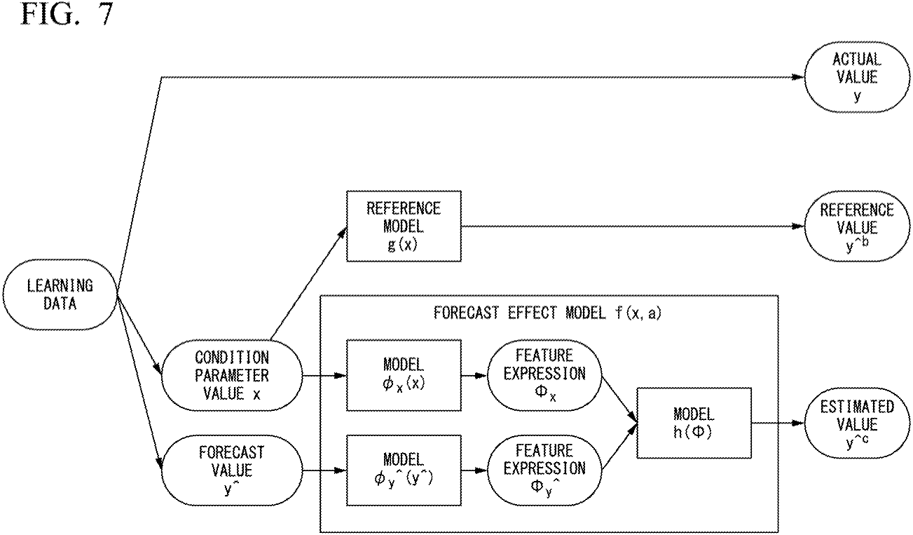

FIG. 7 is a diagram showing a third example of a configuration of a model for the forecast support device 100 to robustly perform learning of the forecast effect model against a bias in the distribution of forecast values y^.

In the example of FIG. 7, the model ϕₓ receives the input of the condition parameter value x and outputs a feature expression. The feature expression output by the model ϕₓ is written as Φₓ. The feature expression Φₓ is data representing the feature of the condition parameter value x, which is the input data to the model Φₓ.

The model ϕₓ is also written as ϕₓ(x).

The model ϕ_{y^} outputs a feature expression upon receiving input of the forecast value y^. The feature representation output by the model ϕ_{y^} is written as Φ_{y^}. The feature expression Φ_{y^} is data representing the feature of the forecast value y^, which is the input data to the model ϕ_{y^}.

The model ϕ_{y^} is also written as ϕ_{y^}(y^).

In the example of FIG. 7, the model h outputs the estimated value y^^{c} upon receiving the input of the feature expression Φ, which is a combination of the feature expression Φₓ and the feature representation Φy.

A forecast effect model f is constituted by combining the model ϕₓ, the model ϕ_{y^}, and the model h.

The learning unit 192 performs learning of at least one of the model ϕₓ and the model ϕ_{y^} such that the feature expression Φₓ and the feature expression Φ_{y^} are independent as random variables.

As a result, a distribution of the feature expression Φ_{y^} that does not depend on the value of the condition parameter value x can be obtained. Therefore, it is considered that the model ϕ_{y^} extracts a feature that does not depend on the condition parameter value x from the forecast value y^ obtained in combination with the condition parameter value x as the measured data, and outputs the feature as the feature expression ϕ_{y^}. As a result, the learning unit 192 can perform learning of the model h so as to reflect the relationship between the forecast value y^ and the actual value y included in the learning data in the model h for not only the forecast value y^ for each condition parameter value x indicated by the learning data but also the entire distribution of the forecast value y^. In this respect, it is expected that the forecast effect model f, which is a combination of the model ϕₓ, the model ϕ_{y^}, and the model h, has high accuracy.

The method by which the learning unit 192 performs learning of at least one of the model ϕₓ and the model ϕ_{y^} so that the feature expression ϕₓ and the feature representation ϕ_{y^} become independent as random variables is not limited to a specific method. For example, the learning unit 192 may perform learning of at least one of the model ϕₓ and the model ϕ_{y^} so as to reduce the Hilbert-Schmidt independence criterion (HSIC).

The HSIC in this case is shown as Equation (10).

$$H S I C \left(\left\{{ϕ}_{x} \left(x\right)\right\} , \left\{{ϕ}_{y \hat{}} \left(y \hat{}\right)\right\}\right)$$

“HSIC” indicates the value of the Hilbert-Schmidt independence criterion. “{ϕₓ(x)}” indicates a set of feature expressions Φₓ output by the model ϕₓ. “{ϕ_{y^}(y^)}” indicates a set of feature representations Φ_{y^} output by the model ϕ_{y^}.

If the independence of the condition parameter value x and the forecast value y^ measured by HSIC is not satisfied (that is, if p(x, y^) ≠ p(x)p(y)), the probability distribution of the forecast value y^ under the conditional parameter value x is not uniformly distributed (that is, p(y^|x) ≠ Uniform). Therefore, as in the above case, the learning unit 192 performs learning of the models ϕ_{y^} and Φₓ so that the distributions of the expressions that are their outputs are independent, whereby the robustness of the forecast value y^ to bias depending on the condition parameter value x is expected to be obtained.

Alternatively, the learning unit 192 may perform learning of at least one of the model ϕₓ and model ϕ_{y^} by a method other than the method that minimizes the inter-distribution distance between the distribution of the feature expression ϕ_{y^} output by the model φ_{y^} in response to the input of the condition parameter value x and the forecast value y^ contained in the training data and the distribution of the feature expression Φ_{rand}. output by the model ϕ_{y^} in response to the input of the condition parameter value x and the forecast value y^_{rand} randomly selected based on a uniform distribution.

For example, the learning unit 192 may perform learning of at least one of the model ϕₓ and the model ϕ_{y^} using the evaluation function that gives a lower evaluation the smaller the HSIC shown in Equation (10).

In this case, the independence of the condition parameter value x and the forecast value y^ provides the robustness of the model ϕ_{y^} against bias in the distribution of the forecast value y^.

As described above, the model ϕₓ outputs the feature expression Φₓ in response to the input of the condition parameter value x. The model ϕ_{y^} outputs the feature expression Φ_{y^} in response to the input of the forecast value y^. The learning unit 192 uses an evaluation function including an evaluation index of independence between the distribution of the feature expression Φₓ and the distribution of the feature expression Φ_{y^} to perform learning of at least one of the model ϕₓ and the model ϕ_{y^} so as to increase the independence indicated by the evaluation index.

As a result, a distribution of the feature expression Φ_{y^} that does not depend on the value of the condition parameter value x can be obtained. Therefore, it is considered that the model ϕ_{y^} extracts a feature that does not depend on the condition parameter value x from the forecast value y^ obtained in combination with the condition parameter value x as the learning data, and outputs the feature as the feature expression ϕ_{y^}. As a result, the learning unit 192 can perform learning of the model h so as to reflect the relationship between the forecast value y^ and the actual value y included in the learning data in the model h for not only the forecast value y^ for each condition parameter value x indicated by the learning data but also the entire distribution of the forecast value y^. In this respect, it is expected that the forecast effect model f, which is a combination of the model ϕₓ, the model ϕ_{y^}, and the model h, has high accuracy.

Thus, according to the forecast support device 100, the forecast effect model can be learned robustly against the bias in the distribution of forecast values y^.

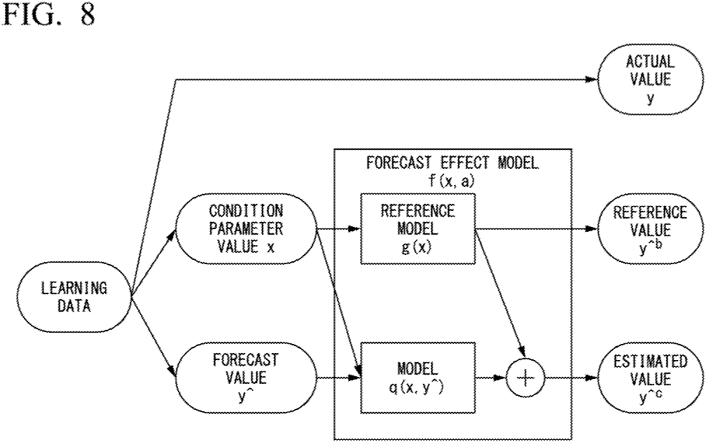

FIG. 8 is a diagram showing a fourth example of the configuration of the model for the forecast support device 100 to robustly learn a forecast effect model against the bias in the distribution of forecast values y^.

In the example of FIG. 8, the model q receives the input of the condition parameter value x and the forecast value y^, and outputs a value corresponding to the difference obtained by subtracting the reference value y^{^b} from the estimated value y^{^c}. The output of model q is written as r_{c}. Representing the reference value y^{^b} by the output “g(x)” of the reference model g, r_{c} is expressed as in Equation (11).

$${r}_{c} = y {\hat{}}^{c} - g \left(x\right)$$

The model q is also written as q(x,y^).

The additive model, indicated by “+” in FIG. 8, adds the output of the reference model g(x) and the output of the model q(x,y^). The output of the additive model corresponds to the estimated value y^{^c}.

The forecast effect model f is constituted by combining the reference model g, the model q, and the additive model.

The forecast effect model f in this case is shown as in Equation (12).

$$f \left(x , y \hat{}\right) = g \left(x\right) + q \left(x , y \hat{}\right)$$

Here, the calculation by the reference model g can be regarded as a conditional average of the actual values y under the condition indicated by the condition parameter value x, and is expressed by Equation (13).

$$g \left(x\right) ≅ {E}_{y \hat{} \sim μ \left(y \hat{} \left|x\right)\right)} \left[y \left|x\right)\right]$$

“E” indicates the expected value. “y^~µ(y^|x)” indicates that the distribution of forecast values y^ follows the distribution according to the condition parameter value x (distribution of forecast values y^ in learning data). “E[y|x]” indicates the expected value of the actual value y with respect to the forecast value y^ conditioned on the condition parameter value x.

In the example of FIG. 8, ideally, the reference model g can be regarded as outputting the value of the portion of the actual value y that does not depend on the forecast value y based on the condition parameter value x. The model q can ideally be viewed as outputting the portion of the actual value y that depends on both the condition parameter value x and the forecast value y^ as a correction to the output of the reference model g.

The data acquisition unit 191 calculates a value r_{c} obtained by subtracting the output of the reference model g in the sample from the actual value y included in the learning data sample, as shown in Equation (11), and generates training data in which the actual value y is replaced by the calculated value r_{c}. Here, the actual value y is applied to Equation (11) as the correct answer for the estimated value y^{^c}.

The learning unit 192 uses the learning data generated by the data acquisition unit 191 to learn the model q so as to output the value r_{c} obtained by subtracting from the actual value y included in a sample of the learning data the output of the reference model g in the sample, as shown in Equation (11).

Here, in the learning of the entire forecast effect model f, which is affected by both the condition parameter value x and the forecast value y^, the input data space is a wide and complicated function, so it is possible that the input data space is too large and the function is too complex to obtain sufficient samples to train with high accuracy. For example, as described with reference to FIG. 4, it is conceivable that the learning data cannot be sufficiently reflected for a forecast value y^ not shown in the learning data. In particular, it is conceivable that the learned data may not be sufficiently reflected in the forecast values y^ determined during operation due to deviations in the forecast values y^ between learning and operation.

On the other hand, the reference model g does not receive an input of the forecast value y^. In addition, since the model q is only required to predict the value r_{c} for which the influence of the condition parameter value x is excluded to a certain extent in advance, it is considered that a model expressed in terms of a simple function can provide sufficient approximation accuracy compared to the forecast effect model f. In this respect, it is expected that the learning unit 192 can perform learning of the reference model g and the model q with higher accuracy.

Here, a simple function may mean that the sum of squares of parameters when the function is expressed as a neural network is small. In addition, the simple function referred to here may be a ρ-Lipschitz continuous function with respect to a small constant ρ.

The learning unit 192 can also perform learning of the reference model g and the forecast effect model f by supervised learning, and in this respect, it is expected that the learning can be performed with high accuracy and that the load on the learning unit 192 is relatively small.

The learning unit 192 first performs learning of the reference model g using learning data. Then, the learning unit 192 uses the learned reference model g to calculate the reference value y^{^b} for each sample of the learning data. The data acquisition unit 191 generates learning data in which the actual value y of the sample is replaced with the difference r_{c}. The learning unit 192 performs learning of the model q using the learning data in which the actual value y is replaced with the difference r_{c}.

As described above, the learning unit 192 calculates the reference value y^{^b} according to the condition parameter value x using the reference model g. The data acquisition unit 191 acquires training data including the condition parameter value x, the forecast value y^, and the difference r_{c} obtained by subtracting the reference value y^{^b} from the actual value y according to that condition parameter value x and that forecast value y^. The learning unit 192 performs learning of the model q using the learning data acquired by the data acquisition unit 191. The model q outputs an estimated value of the difference r_{c} obtained by subtracting the reference value y^{^b} from the actual value y for the input of the condition parameter value x and the forecast value y^.

The estimated value y^{^c} corresponds to the estimated value of the actual value y when the forecast value y^ is forecast.

It is conceivable that since the model q outputs the difference r_{c} upon receiving inputs of the condition parameter value x and the forecast value y^, a correlation between the condition parameter value x and the model output is lower (smaller) compared to the case where the forecast effect model f outputs the estimated value y^{^c} upon receiving inputs of the condition parameter value x and the forecast value y^. This suggests that model q can provide sufficient approximation accuracy with a model represented by a simple function compared to the forecast effect model f.

Also, the learning unit 192 can perform learning of the model q by supervised learning using the difference r_{c} as the correct answer. In this respect, it is expected that the learning unit 192 can perform learning of the model q with relatively high accuracy.

Also, if f(x y^) = g(x) + q(x, y^), as in Equation (12) above, and g(x) is learned to estimate a conditional expectation that is marginalized with respect to the forecast value y^ over the data distribution, the model q is expected to be robust with respect to the estimation error of the reference model g. “A conditional expectation that is marginalized with respect to the forecast value y^ over the data distribution” means the right side of Equation (13), that is, “E_{y^~µ(y^|x)}[y|x]”. Here, the robustness of the model q to the estimation error of the reference model g means that the estimation error of the reference model g has little influence on the estimation of the model q. More specifically, robustness here means a small deterioration in the estimation accuracy of the model q when the estimated value of the reference model g slightly changes from the true value.

For applications such as traffic forecasts, the reference value y^{^b} output by the reference model g is unnecessary, and it is sufficient that there exist a difference r_{c} output by the model q. In this regard, the accuracy of the estimation of g(x) per se is not an issue.

Also, since the hypothesis space of the reference model g is relatively small and learning thereof can be performed by supervised learning, it is expected that the learning unit 192 can perform learning of the reference model g with relatively high accuracy. In this respect, when the learning unit 192 calculates the reference value y^{^b} based on Equation (13) using the reference model g, calculation of the reference value y^{^b} is expected to be performed with high accuracy.

Thus, according to the forecast support device 100, the forecast effect model can be learned robustly against the bias in the distribution of forecast values y^.

The forecast support device 100 may be used to perform learning of forecast values taking into account the effect of the forecast for a plurality of points.

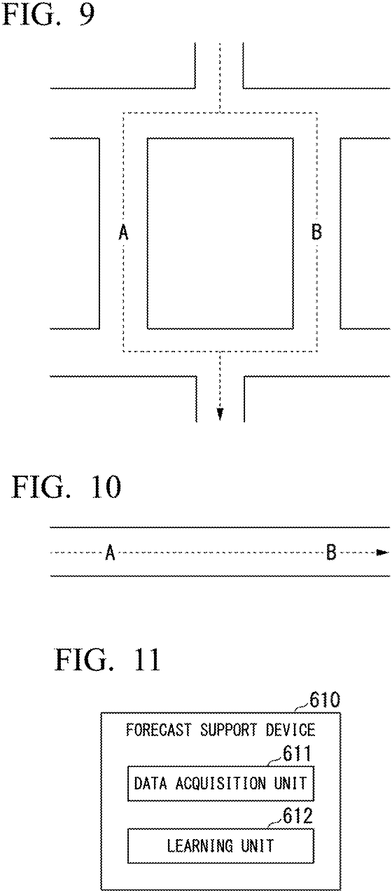

FIG. 9 is a diagram showing a first example of a plurality of points targeted for forecast.

In the example of FIG. 9, a road including point A and a road including point B are provided in parallel. Points A and B are in an alternate relationship, such that a vehicle can selectively pass through either point A or point B.

In the example of FIG. 9, when traffic congestion at point A is forecast, it is conceivable that some drivers will avoid point A and pass through point B. This would result in a decrease in traffic at point A and an increase in traffic at point B.

In this way, when two points are in an alternative relationship, the effect of a forecast for a certain point is that the increase/decrease in the actual value at that point is the opposite of the increase/decrease in the actual value at the other point. That is, if the actual value at one point where the forecast is made is higher than it would have been if the forecast were not made, the actual value at the other point is lower than it would have been if the forecast were not made. Also, if the actual value at the one point where the forecast is made is less than it would have been if the forecast were not made, the actual value at the other point is greater than it would have been if the forecast were not made.

In addition to alternative relationships in terms of location, alternative relationships in terms of time are also conceivable. For example, if evening traffic congestion is forecast for a certain point, it is conceivable that some drivers will pass through that point late at night after the congestion has cleared. This would reduce evening traffic and increase late-night traffic.

FIG. 10 is a diagram showing a second example of a plurality of points targeted for forecast.

In the example of FIG. 10, point A and point B are included in a single road. A vehicle passing point A in the direction of the arrow in FIG. 10 will also pass point B, except in cases where the vehicle stops en route or turns around en route.

In the example of FIG. 10, if traffic congestion at point A is forecast, some drivers may avoid passing point A at the time when the traffic congestion is expected. This will result in a decrease in traffic at both points A and B.

Not only in the case of a single road, as in the example in FIG. 10, but also when there is a branch between points A and B, the effect of the forecast for point A may also affect the traffic volume at point B.

As input data in this case, the data acquisition unit 191 may acquire data in which the forecast value y^ₙ and the actual value yₙ are represented by m-dimensional vectors that represent data for m points, respectively, with the “D = {xₙ, y^ₙ, yₙ}” shown in Equation (4). For example, a positive real number can be written as R₊ and expressed as y^ₙ,yₙ ∈ R₊^{m}.

The learning unit 192 performs learning of the forecast effect model f expressed as “y = f(x, y^)” like the above Equation (1). Both y and y^ here are represented by m-dimensional vectors indicating data for m points.

The forecast effect model f may be configured using a Graph Neural Network (GNN), but is not limited thereto.

The learning unit 192 may perform learning of the forecast effect model f by a general supervised learning method. Alternatively, the learning unit 192 may perform learning of the forecast effect model f by any of the methods described with reference to FIGS. 5 to 8.

Also, the learning unit 192 may use objective function including a penalty that imposes a contraction mapping property of the function to perform learning of the forecast effect model f with an. If X is an n-dimensional real vector and ^{X}’ ^{y} ^{∈}^{X}, then the fact that the map F : X → X is a contraction map is equivalent to the fact that there exists some µ(0≤µ< 1) for ^{x,} ^{y} ^{∈} ^{X} and that Equation (14) holds.

$$\left‖F \left(x\right) - F \left(y\right)\right‖ \left(\leq μ\right‖ \left(x - y\right‖$$

“||·||” represents the norm of X.

In the contraction map, there is only one fixed point according to Banach’s fixed point theorem, and the fixed point can be obtained as the convergence destination of the iteration shown in Equation (15).

$$y {\hat{}}^{\left(k\right)} = f \left(x , y {\hat{}}^{\left(k - 1\right)}\right)$$

y^^{(k)} denotes the value of y^ at the kth iteration.

For example, the learning unit 192 may use an objective function including a penalty term represented by Equation (16).

$$\frac{1}{N} {\sum }_{n}^{N} \text{max} \left(0 , \frac{d \left(f \left({x}_{n} , y {\hat{}}_{1}\right) , f \left({x}_{n} , y {\hat{}}_{2}\right)\right)}{d \left(y {\hat{}}_{1} , y {\hat{}}_{2}\right) - 1 + ε}\right)$$

N is a positive integer representing the number of samples. n is an identification number for identifying a sample, where n = 1, 2, ..., N.

ε is a constant representing a margin, and 0 ≤ ε < 1. For example, the value of _{ε} may be set to 0.1.

y^1 and y^2 can be generated by an appropriate method such as sampling according to a normal distribution N(y^ₙ, εI) around the forecast value y^ₙ included in the learning data.

Any distance (Norm) can be used as d. For example, the L2 distance may be used as d. Alternatively, the Lp distance (norm of residual error) weighted for each dimension may be used as d.

Here, depending on factors such as the size of the road, it is conceivable that the effect of the forecast at a certain point will be magnified at another point. For example, if the forecast value for an arterial road is slightly increased, it is conceivable that the degree of congestion on nearby community roads will increase significantly.

In such a case, to appropriately reflect the difference in the degree of influence of the effect of the forecast for each point on the distance d to facilitate obtaining a contraction map, as shown in Equation (17), the distance d weighted by the number of lanes wᵢ per point may be used.

$${\left‖e\right‖}_{w , p} = \sqrt[p]{{\sum }_{i} {\left({w}_{i} , {e}_{i}\right)}^{p}}$$

i is an identification number for identifying each point.

Wᵢ is a weighting factor according to the number of lanes per point.

eᵢ represents a value for each point for which the distance is to be calculated.

p represents a multiplier. Equation (17) uses p-th power and p-th root distances, but is not limited thereto.

The method by which the fixed-point calculation unit 193 obtains the fixed point is not limited to the fixed point iteration according to Equation (15) above. For example, the fixed-point calculation unit 193 may search for the fixed point using Newton’s method. Alternatively, the fixed-point calculation unit 193 may search for the fixed point by line search using Equation (18).

$${\left(y {\hat{}}^{\left(k + 1\right)} = y {\hat{}}^{\left(k\right)} - α \frac{d}{d y \hat{}} \left\{y \hat{} - f \left(x , y \hat{}\right)\right\}\right|}_{y \hat{} = y {\hat{}}^{\left(k\right)}}$$

α denotes a scalar constant factor for search optimization.

Note that for a point that is not subject to forecasting among the plurality of points, the forecast value for that point may not be included in the learning data.

In addition, if it is not necessary to examine the effect of the forecast for the target point of the forecast, and it is sufficient to examine the effect of the forecast only for other points, the actual value for the point to be forecast need not be included in the learning data. For example, if the traffic volume at point A is forecast and the traffic volume at point B is desired to become at a certain level, and the accuracy of the forecast is not required, the actual value of the traffic volume at point A does not need to be included in the learning data.

The fixed-point calculation unit 193 may calculate the fixed point y^* using the model q(x, y^) of the above Equation (12). Since the reference model g(x) corresponding to the portion that does not depend on the forecast value y^ is removed, the model q(x, y^) becomes a relatively simple model, and in this respect, the fixed-point calculation unit 193 can calculate the fixed point y^* with high accuracy.

In this case, the learning unit 192 may perform learning of the model q(x, y^) so that the model q(x, y^) becomes the above-described monotonically non-increasing model. Alternatively, the learning unit 192 may perform learning of the model q(x, y^) so as to impose the above contraction mapping property on the model q(x, y^).

As described above, the data acquisition unit 191 acquires learning data including a forecast value and an actual value when a forecast of that forecast value is made. The learning unit 192 uses the obtained learning data to learn the relationship between the forecast value and the actual value when a forecast of that forecast value is made.

According to the forecast support device 100, when making a forecast, the impact of disclosure of the forecast value on the actual value can be reflected in the forecast value. That is, according to the forecast support device 100, it is possible to determine the forecast value in consideration of the influence of a forecast being made of a certain forecast value. According to the forecast support device 100, in this respect, the forecast can be made with high accuracy.

In addition, the fixed-point calculation unit 193 calculates, on the basis of the relationship between a forecast value and an actual value when a forecast of that forecast value is made, the forecast value at which the forecast value and the actual value are estimated to match when a forecast is made.

It is expected that the forecast value and the actual value will match because the forecast support device 100 forecasts the forecast value calculated by the fixed-point calculation unit 193. According to the forecast support device 100, in this respect, the forecast can be made with high accuracy.

In addition, when a distribution of forecast values included in learning data is in a dependent relationship with a condition parameter value or is biased in comparison with a uniform distribution, the learning unit 192 robustly performs learning of a forecast effect model for forecast value calculation with respect to the dependency on the condition parameter value or the bias in the distribution of the forecast values.

As a result, for forecast values determined by the forecast support device 100, it is possible to remove or reduce the influence of deviations among the forecast values between learning and operation. According to the forecast support device 100, in this respect, the forecast can be made with high accuracy.

In addition, the learning unit 192 performs leaning of a forecast effect model using an evaluation function that gives a lower evaluation when the magnitude correlation of an actual value when a forecast of a certain forecast value is made and an estimated value of the actual value when the forecast of that forecast value is made, and the magnitude correlation of the actual value and the forecast value do not match.

Thus, it is expected that the learning unit 192 performs learning of the forecast effect model so that the fixed-point calculation unit 193 can obtain the fixed point with high accuracy.

In addition, the learning unit 192 performs learning of the relationship between forecast values and actual values using an evaluation function that gives a lower evaluation when, for any two forecast values, the distance between actual values estimated when a forecast is made of those forecast values for each of them respectively is equal to or greater than the distance between the two forecast values.

According to the forecast support device 100, it is expected that the forecast effect model can be obtained by contraction mapping, and the fixed point can be uniquely obtained. The forecast support device 100 can forecast with high accuracy in that this fixed point can be used as a forecast value.

In addition, the data acquisition unit 191 acquires learning data including a forecast value for a first point and an actual value at a second point when a forecast is made of the forecast value for the first point. The learning unit 192 performs learning of the relationship between the forecast value for the first point and the actual value at the second point when a forecast is made of the forecast value for the first point.

According to the forecast support device 100, a forecast for a certain point can be made in consideration of the influence of the forecast for another point. According to the forecast support device 100, in this respect, the forecast can be made with high accuracy.

In addition, the data acquisition unit 191 acquires learning data including a forecast value for a first time and an actual value at a second time when a forecast is made of the forecast value for the first time. The learning unit 192 performs learning of the relationship between the forecast value for the first time and the actual value at the second time when a forecast is made of the forecast value for the first time.

According to the forecast support device 100, a forecast for a certain time can be made in consideration of the influence of the forecast for another time. According to the forecast support device 100, in this respect, the forecast can be made with high accuracy.

FIG. 11 is a diagram illustrating an example of the configuration of the forecast support device according to an example embodiment.

In the configuration shown in FIG. 11, a forecast support device 610 includes a data acquisition unit 611 and a learning unit 612.

With such a configuration, the data acquisition unit 611 acquires learning data including a forecast value and an actual value when a forecast of that forecast value is made. The learning unit 612 uses the obtained learning data to perform learning of the relationship between the forecast value and the actual value a forecast of that forecast value is made.

The data acquisition unit 611 corresponds to an example of a data acquisition means. The learning unit 612 corresponds to an example of a learning means.

According to the forecast support device 610, when making a forecast, the impact of disclosure of the forecast value on the actual value can be reflected in the forecast value. That is, according to the forecast support device 610, it is possible to determine the forecast value in consideration of the impact of a forecast made of a certain forecast value. According to the forecast support device 610, in this respect, the forecast can be made with high accuracy.

The function of the data acquisition unit 611 can be implemented using the functions of the data acquisition unit 191 shown in FIG. 2, for example. The function of the learning unit 612 can be implemented using the functions of the learning unit 192 shown in FIG. 2, for example.

FIG. 12 is a diagram showing an example of the procedure of processing in a forecast support method according to an example embodiment.

In the process shown in FIG. 12, the forecast support method includes the steps of acquiring data (Step S611) and learning (Step S612).

In acquiring data (Step S611), the forecast support device acquires learning data including a forecast value and an actual value when a forecast of that forecast value is made.

In the learning (Step S612), a forecast support device uses the obtained learning data to learn the relationship between the forecast value and the actual value when a forecast of that forecast value is made.

According to the forecast support method shown in FIG. 12, when making a forecast, the impact of disclosure of the forecast value on the actual value can be reflected in the forecast value. That is, according to the forecast support method shown in FIG. 12, the forecast value can be determined in consideration of the influence of the forecast with a certain forecast value. According to the forecast support method shown in FIG. 12, in this respect, the forecast can be made with high accuracy.

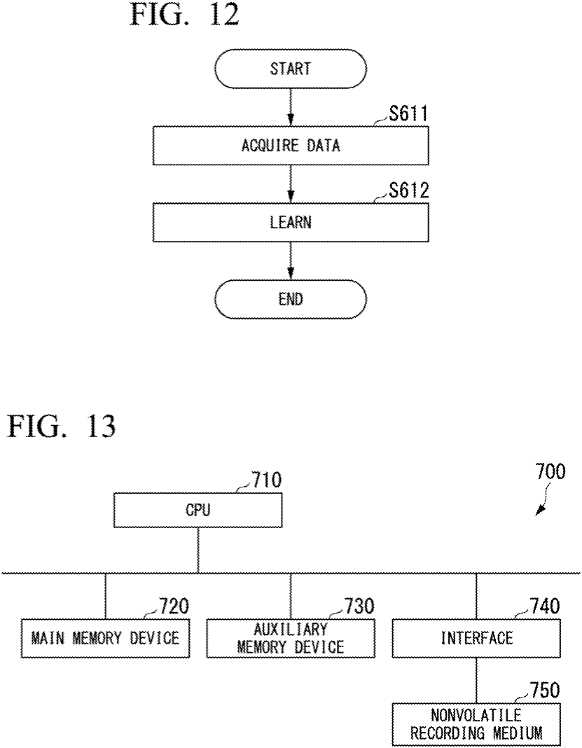

FIG. 13 is a schematic block diagram showing the configuration of a computer according to at least one example embodiment.

With the configuration shown in FIG. 13, a computer 700 includes a CPU 710, a main storage device 720, an auxiliary storage device 730, an interface 740, and a nonvolatile recording medium 750.

One or more of the forecast support device 100 and the forecast support device 610 or a part thereof may be implemented in the computer 700. In that case, the operation of each processing unit described above is stored in the auxiliary storage device 730 in the form of a program. The CPU 710 reads out the program from the auxiliary storage device 730, deploys the program in the main storage device 720, and executes the above processing according to the program. In addition, the CPU 710 secures storage areas corresponding to the storage units described above in the main storage device 720 according to the program. Communication between each device and another device is performed by the interface 740 having a communication function and performing communication under the control of the CPU 710. The interface 740 also has a port for the nonvolatile recording medium 750 and reads information from the nonvolatile recording medium 750 and writes information to the nonvolatile recording medium 750.

When the forecast support device 100 is implemented in the computer 700, the control unit 190 and operations of its respective units are stored in the auxiliary storage device 730 in the form of a program. The CPU 710 reads out the program from the auxiliary storage device 730, deploys the program in the main storage device 720, and executes the above processing according to the program.

In addition, the CPU 710 secures a storage area corresponding to the storage unit 180 in the main storage device 720 according to the program.

Communication with another device by the communication unit 110 is performed by the interface 740 having a communication function and operating under the control of the CPU 710.

Display by the display unit 120 is executed by the interface 740 having a display device and displaying various images under the control of the CPU 710.

Acceptance of a user operation by the operation input unit 130 is executed by the interface 740 having input devices such as a keyboard and a mouse, accepting a user operation, and outputting information indicating the accepted user operation to the CPU 710.

When the forecast support device 610 is implemented in the computer 700, operations of the data acquisition unit 611 and the learning unit 612 are stored in the auxiliary storage device 730 in the form of a program. The CPU 710 reads out the program from the auxiliary storage device 730, deploys the program in the main storage device 720, and executes the above processing according to the program.

In addition, the CPU 710 secures a storage area in the main storage device 720 for processing performed by the forecast support device 610 according to the program.

Communication between the forecast support device 610 and another device is performed by the interface 740 having a communication function and operating under the control of the CPU 710.

Interaction between the forecast support device 610 and the user is executed by the interface 740 having an input device and an output device, presenting information to the user through the output device under the control of the CPU 710, and accepting user operations through the input device.

Any one or more of the programs described above may be recorded in the nonvolatile recording medium 750. In this case, the interface 740 may read the program from the nonvolatile recording medium 750. Then, the CPU 710 may directly execute the program read by the interface 740, or may execute the program after temporarily storing the program in the main storage device 720 or the auxiliary storage device 730.

A program for executing all or part of the processing performed by the forecast support device 100 and the forecast support device 610 may be recorded on a computer-readable recording medium, and the program recorded on the recording medium may be read and executed by a computer system to perform the processing of each part. It should be noted that the “computer system” referred to here includes an operating system and hardware such as peripheral devices.

In addition, a “computer-readable recording medium” refers to portable media such as flexible discs, magneto-optical discs, Read Only Memory (ROM), Compact Disc Read Only Memory (CD-ROM) and the like, and to storage devices such as hard disks that are built into a computer system. Furthermore, the program may be for realizing some of the functions described above, or may be capable of realizing the functions described above in combination with a program already recorded in the computer system.

While preferred example embodiments of the invention have been described and illustrated above, it should be understood that these are exemplary of the invention and are not to be considered as limiting. Additions, omissions, substitutions, and other modifications can be made without departing from the scope of the present disclosure. Accordingly, the invention is not to be considered as being limited by the foregoing description, and is only limited by the scope of the appended claims.

What is claimed is:

1. A forecast support device comprising:
a memory configured to store instructions; and
a processor configured to execute the instructions to:
acquire learning data including: a forecast value; and an actual value when the forecast value is disclosed; and
train a model indicating a relationship between: the forecast value; and the actual value when the forecast value is disclosed, by using the learning data.

2. The forecast support device according to claim 1, the processor is configured to execute the instructions to calculate, based on the trained model, a forecast value at which the forecast value and an actual value are estimated to match when a forecast is disclosed.

3. The forecast support device according to claim 1, wherein the processor is configured to execute the instructions to, robustly train a forecast effect model when a distribution of forecast values included in learning data is in a dependent relationship with a condition parameter value or is biased in comparison with a uniform distribution, the forecast effect model being for forecast value calculation with respect to the dependency on the condition parameter value or the bias in the distribution of the forecast values.

4. The forecast support device according to claim 1, wherein the processor is configured to execute the instructions to perform the training based on an evaluation function that gives a lower evaluation when a first relation and a second relation do not much, the first relation indicating a magnitude correlation of an actual value when a certain forecast value is disclosed and an estimated value of the actual value when the certain forecast value is disclosed, the second relation indicating a magnitude correlation of the actual value when the certain forecast value is disclosed and the certain forecast value.

5. The forecast support device according to claim 1, wherein the processor is configured to execute the instructions to train a model indicating a relationship between forecast values and actual values by using an evaluation function that gives a lower evaluation when a first distance is equal to or greater than a second distance between arbitrary two forecast values, the first distance indicating a distance between an actual value estimated when one of the arbitrary two forecast values is disclosed and an actual value estimated when the other one of the arbitrary two forecast values is disclosed.

6. The forecast support device according to claim 1, wherein the processor is configured to execute the instructions to:
acquire learning data including: a forecast value for a first point; and an actual value at a second point when the forecast value for the first point is disclosed; and
train a model indicating a relationship between: the forecast value for the first point; and the actual value at the second point when the forecast value for the first point is disclosed.

7. The forecast support device according to claim 1, wherein the processor is configured to execute the instructions to:
acquire learning data including: a forecast value for a first time; and an actual value at a second time when the forecast value for the first time is disclosed; and
perform learning of a relationship between: the forecast value for the first time; and the actual value at the second time when the forecast value for the first time is disclosed.

8. A forecast support method executed by a forecast support device, comprising:
acquiring learning data including: a forecast value; and an actual value when the forecast value is disclosed; and
training a model indicating a relationship between: the forecast value; and the actual value when the forecast value is disclosed, by using the learning data.

9. A non-transitory computer readable recording medium that stores a program for causing a computer to execute:
acquiring learning data including: a forecast value; and an actual value when the forecast value is disclosed; and
training a model indicating a relationship between: the forecast value; and the actual value when the forecast value is disclosed, by using the learning data.
